(19) United States
(12) Patent Application Publication
(10) Pub. No.: US 2025/0210984 A1
(43) Pub. Date: Jun. 26, 2025

(54) HIERARCHICAL DISTRIBUTED CONTROL METHOD AND DEVICE FOR MICROGRID CLUSTER WITH HETEROGENEOUS BATTERIES

(71) Applicant: WUHAN UNIVERSITY, Hubei (CN)

(72) Inventors: Xiaoqing LU, Hubei (CN); Shi CHEN, Hubei (CN); Qian ZHANG, Hubei (CN)

(73) Assignee: WUHAN UNIVERSITY, Hubei (CN)

(21) Appl. No.: 18/988,893

(22) Filed: Dec. 20, 2024

(30) Foreign Application Priority Data
Dec. 25, 2023 (CN) 202311810350.X

(51) Int. Cl. H02J 1/10; H01M 8/04992; H01M 8/18; H01M 10/0525; H01M 16/00

(52) U.S. Cl. CPC H02J 1/10; H01M 8/04992; H01M 8/188; H01M 10/0525; H01M 16/006; H01M 2220/10; H01M 2250/10; H01M 2250/402

(57) ABSTRACT

The invention pertains to the control technology of microgrid energy storage systems, particularly to a hierarchical distributed control method and device for microgrid cluster with heterogeneous batteries. This method includes primary droop control, two-layer voltage regulation control, and two-layer power management control. The incremental cost of heterogeneous batteries is physically defined as the partial derivative of energy loss with respect to output power. A cooperative control method for the incremental cost of multiple heterogeneous battery units is proposed, which can achieve economic power distribution among multiple heterogeneous battery units while meeting the constraints of charging/discharging power, SoC, and power balance. This invention's method integrates battery types where charging efficiency is tied to charging power with those where charging efficiency is connected to SoC, ensuring ease of expansion. Even with the introduction of a new battery type in the microgrid cluster, the method continues to be effective.

### CROSS-REFERENCE TO RELATED APPLICATION

This application claims the priority benefit of China Application Serial Number 202311810350.X, filed on Dec. 25, 2023. The entirety of the above-mentioned patent application is hereby incorporated by reference and made a part of this specification.

### BACKGROUND

### Technical Field

This invention belongs to the technical field of microgrid energy storage system control, and particularly relates to a hierarchical distributed control method and device for the microgrid cluster with heterogeneous batteries.

### Description of Related Art

In the microgrid domain, strategies for handling voltage regulation and power balance in single microgrid systems, such as active power sharing, maximizing energy efficiency, dynamic supply-demand balance, direct current (DC) bus voltage stabilization, communication reliability under heterogeneous delays, and rolling power fluctuation optimization methods, have been widely advanced. However, with the continuous expansion of application scenarios, the interconnection of various microgrids can form a system of multiple microgrid clusters. Significant research has been conducted in areas like network reconfiguration based on local energy markets, demand response services for multi-microgrids, energy trading markets, optimal energy management frameworks for mixed time scales, voltage setpoint management, and load-sharing between microgrid clusters. However, the current power management and operational control strategies of these microgrid clusters are all equipped with the same type of energy storage components.

In actual microgrid clusters, it is relatively unlikely that all microgrids will be equipped with the same type of energy storage components, and the expansion of microgrid clusters often requires the integration of various types of batteries to meet different power demand scenarios. Current research mainly focuses on the coordination between batteries and supercapacitors to achieve autonomous power sharing. Recently, hybrid energy storage systems that integrate vanadium redox flow batteries with lithium-ion batteries have emerged as a solution to meet the varied power demands in microgrid clusters. By integrating the unique features of each component, a hybrid energy storage system comprising vanadium redox flow and lithium-ion batteries can capitalize on the advantages of both technologies, while minimizing their individual drawbacks. However, proper power distribution among the internal units of hybrid batteries is crucial, as improper coordination can result in additional power losses, which grow more prominent as the microgrid cluster scales up. Present economic management strategies for vanadium redox flow and lithium-ion hybrid systems predominantly optimize energy costs at the tertiary control layer for longer time scales, often neglecting the power losses occurring at the secondary control layer over shorter time scales. Therefore, for hybrid energy storage systems in microgrid clusters, studying the economic operation power management and voltage regulation control between heterogeneous batteries over different time scales poses greater challenges and holds more practical engineering significance.

### SUMMARY

This invention provides a hierarchical distributed control method for a microgrid cluster with heterogeneous batteries to address the issue of economic power distribution and voltage regulation control among hybrid energy storage systems in DC microgrid clusters in existing technology. It enables the economic distribution of power and voltage regulation both within individual microgrid energy storage systems and across multiple microgrid energy storage systems.

This invention provides a hierarchical distributed control method for a microgrid cluster with heterogeneous batteries, including the following.

S1. To resolve the problems of economic operation and voltage regulation among energy storage systems within microgrid clusters over different time scales, this invention has developed a two-layer control structure, as illustrated in FIG. 1. This structure incorporates primary droop control, two-layer voltage regulation control, and two-layer power management control, enabling economic power distribution and voltage regulation within and between different microgrid energy storage systems.

S2. To implement the two-layer control structure mentioned in S1, this invention targets the energy storage systems of the microgrid cluster that utilize mixed batteries with different characteristics to meet the needs of various scenarios. It standardizes the physical definition of incremental costs of heterogeneous battery units to achieve economic power distribution among different battery units.

S3. Based on the two-layer control structure proposed in S1, P-V primary droop control is employed to ensure that the output voltage of the i-th converter quickly tracks the nominal voltage value.
S4. Based on the two-layer control structure proposed in S1, a two-layer voltage regulation controller is designed. When the control time meets conditions and 0<\tilde{τ}/\tilde{T}<ψ^{V}, the two-layer voltage regulation control algorithm can achieve the following control objectives:

$${lim}_{t \to ∞} \vert {V}_{s , i} ( t ) - {V}_{s , re} \vert = 0 , {lim}_{t \to ∞} \vert {V}_{k , i} ( t ) - {V}_{k , re} \vert = 0 ,$$

$${lim}_{t \to ∞} \vert {V}_{s , re} ( t ) - {V}^{rated} \vert = 0 , {lim}_{t \to ∞} \vert {V}_{k , re} ( t ) - {V}^{rated} \vert = 0$$

where τ and \tilde{τ} represent the lower-layer control times that represent response speed, while T and \tilde{T} represent the upper-layer control times. Systems with the lithium battery are denoted as s, and those with the vanadium redox flow battery are denoted as k. ψ^{V}=min{ψ_{S}^{V}, ψ_{K}^{V}}, where

$${Ψ}_{S}^{V} {=}^{Δ} \frac{4 {λ}_{min} ( {L}^{S} + {B}^{S} )}{{λ}_{min} ( {\tilde{L}}^{S} + {\tilde{B}}^{S} )} and {Ψ}_{K}^{V} {=}^{Δ} \frac{4 {λ}_{min} ( {L}^{K} + {B}^{K} )}{{λ}_{min} ( {\tilde{L}}^{K} + {\tilde{B}}^{K} )} ,$$

while V^{rated} is the rated value.

S5. Based on the two-layer control structure proposed in S1 and the unified physical definition of incremental costs of heterogeneous battery units from S2, a two-layer power management controller is designed. By setting an appropriate positive condition coefficient γ, the two-layer power management control algorithm can achieve the following control objectives:

$$\begin{matrix}( i ) {lim}_{t \to ∞} \vert {s , i}_{LB}^{} ( t ) - {re , s}_{LB}^{} ( t ) \vert = 0 \\ ( ii ) {lim}_{t \to ∞} \vert {re , s}_{LB}^{} ( t ) - {re , k}_{VRB}^{} ( t ) \vert = 0\end{matrix} and \begin{matrix}( i ) {lim}_{t \to ∞} \vert {k , i}_{VRB}^{} ( t ) - {re , k}_{VRB}^{} ( t ) \vert = 0 \\ ( ii ) {lim}_{t \to ∞} \vert {re , k}_{VRB}^{} ( t ) - {re , l}_{VRB}^{} ( t ) \vert = 0\end{matrix} ,$$

where systems with lithium batteries (LB) are denoted as s, systems with vanadium redox flow batteries (VRB) are denoted as k, and [symbol] represents the incremental cost

According to the hierarchical distributed control method for the microgrid cluster with heterogeneous batteries provided by the present invention, the two-layer control structure described in S1 includes the following.

S11. All nodes in the microgrid cluster system can be divided into representative nodes and non-representative nodes. The representative nodes constitute the upper control structure, and the non-representative nodes form the lower control structure.

S12. In the two-layer control structure, representative nodes are selected from each subnet for performing the distributed consensus control method through the upper-layer communication network \tilde{G}, while the other nodes in the lower layer can coordinate their own states using the leader-follower control method via the communication network G. The two-layer control structure can regulate voltage and distribute power between lithium battery microgrid clusters and vanadium redox flow battery microgrid clusters, as illustrated in FIG. 2.

S13. The lower-layer network of the two-layer control structure adopts the leader-follower control method to ensure each node's stable state is consistent with the representative node's state, enabling voltage restoration, incremental cost coordination, and power balance within an individual microgrid.

S14. The operation of the upper-layer network of the two-layer control structure can be divided into two scenarios: when an external node sends a reference state value to the upper-layer network, the leader-follower control method is applied to force the representative nodes' stable states to match the reference value. Otherwise, the distributed consensus control method is used to ensure that the representative nodes' stable states equal the average of the total initial values.

According to the hierarchical distributed control method for the microgrid cluster with heterogeneous batteries provided by the present invention, the steps for unifying the physical definition of the incremental cost of heterogeneous battery units in S2 include the following.

S21. First, the evaluation method of the state of charge (SoC) for different types of batteries can be expressed as:

$$S \dot{o} {C}_{i} = - {P}_{B , i} {η}_{B , i} / {E}_{B , i}^{rated} i ∈ {v}_{C} ,$$

where ν_{C} represents the set of converters connected to the batteries in the DC microgrid cluster, SoCᵢ, P_{B,i}, η_{B,i}, and E_{B,i}^{rated} denote the SoC, controllable charging power, charging efficiency, and rated capacity of the i-th battery, respectively.

S22. Furthermore, different battery types exhibit different charging efficiencies. For conventional batteries, such as the lithium-ion battery, charging efficiency η_{B,i} can be simplified as a function of charging power. For flow batteries, such as the vanadium redox flow battery, charging efficiency η_{B,i} can be simplified as a function of SoC and charging power. Thus, the charging efficiencies of the lithium-ion and vanadium redox flow batteries can be expressed as:

$$\{ \begin{matrix}{η}_{B , i} = {α}_{i}^{LB} {P}_{B , i} + {β}_{i}^{LB} lithium - ion battery \\ {η}_{B , i} = ( {α}^{VRB} {SoC}_{i}^{VRB} + {b}^{VRB} ) + \frac{{P}_{B , i}^{rated}}{{P}_{B , i} ( t )} ( {c}^{VRB} {SoC}_{i}^{VRB} + {d}^{VRB} ) \\ vanadium redox flow battery\end{matrix} .$$

S23. To design the economic charging control method for mixed battery operation, the optimization objective is proposed to minimize the total consumed power:

$$\begin{matrix}min f ( {P}_{B , i} ) = min {\sum }_{i = 1}^{N} {P}_{B , i} {η}_{B , i} \\ s . t . {\sum }_{i = 1}^{N} {P}_{B , i} = {\sum }_{i = 1}^{N} {P}_{G , i} - {\sum }_{i = 1}^{N} {P}_{L , i} \\ \{ \begin{matrix}{P}_{B , i} = 0 , & if {SOC}_{i} ∉ [ \underline{{SOC}_{i}} , \overline{{SoC}_{i}} ] \\ {P}_{B , i} ∈ [ \underline{{P}_{B , i}} , \overline{{P}_{B , i}} ] , & else\end{matrix}\end{matrix} ,$$

where P_{L}=ΣP_{L,i} represents the total load demand, and ΣP_{G,i} represents the total generation power.

S24. Next, the Lagrange multiplier method is employed for optimization, where the Lagrangian function is given as:

$${F}_{Lag} ( {P}_{B , i} ) = {\sum }_{i = 1}^{n} f ( {P}_{B , i} ) + {\sum }_{i = 1}^{n} {ϖ}_{i} ( {P}_{G , i} - {P}_{L , i} - {P}_{B , i} ) .$$

Then take the partial derivatives:

$$\frac{\partial {F}_{Lag} ( {P}_{B , i} )}{\partial {P}_{B , i}} = \frac{\partial f ( {P}_{B , i} )}{\partial {P}_{B , i}} - {ϖ}_{i} ,$$

where w̅ᵢ represents the Lagrange multiplier of the i-th battery, and thus the economic operation can be achieved by coordinated designing of the Lagrange multipliers for different batteries. Physically, w̅ᵢ also represents the incremental cost of the i-th battery, and thus the incremental cost of heterogeneous batteries is the partial derivative of energy loss with respect to output power for each battery unit, which gives them a unified physical meaning.

Based on the hierarchical distributed control method for the microgrid cluster with heterogeneous batteries provided in this invention, the P-V primary droop control described in S3 includes the following.

S31. The voltage and power output relationship in the P-V primary droop control can be formulated as:

$${V}_{i} - {V}_{i}^{*} = {D}_{i} ( {P}_{i}^{*} - {P}_{i} ) , i ∈ {v}_{C} ,$$

where ν_{C} denotes the set of converters connected to batteries in the DC microgrid cluster, while Vᵢ and Dᵢ are the output voltage and the droop coefficient, respectively. V*ᵢ and P*ᵢ represent the nominal voltage and the nominal active power. The active power injection P*ᵢ satisfies Pᵢ=P_{G,i}−P_{B,i}, where P_{G,i} and P_{B,i} are the generation power and the charging power of the battery, respectively.

S32. Secondary control is needed to eliminate voltage deviation which is inevitably generated in the primary droop control. By driving the charging power P_{B,i} to equal the reference power P_{B,i}^{ref} generated by secondary control, the voltage deviation \hat{V}ᵢ=Vᵢ−V*ᵢ can be restored to zero, i.e.:

$$\begin{matrix}{lim}_{t \to ∞} \vert {P}_{B , i} ( t ) - {P}_{B , i}^{ref} ( t ) \vert = 0 , i ∈ {v}_{C} \\ {lim}_{t \to ∞} {\hat{V}}_{i} ( t ) = 0 , i ∈ {v}_{C}\end{matrix}$$

Based on the hierarchical distributed control method for the microgrid cluster with heterogeneous batteries provided by this invention, the two-layer voltage regulation controller described in S4 includes the following.

S41. The voltage regulation algorithm for a single microgridMGₛ/MGₖ in a lower layer:

$$\{ \begin{matrix}τ {\dot{V}}_{s , i} = {\sum }_{j ∈ {N}_{s , i}} {a}_{ij}^{s} ( {V}_{s , j} - {V}_{s , i} ) + {a}_{i 0}^{s} ( {V}_{s , re} - {V}_{s , i} ) \\ \tilde{τ} {\dot{V}}_{k , i} = {\sum }_{j ∈ {N}_{k , i}} {a}_{ij}^{s} ( {V}_{k , j} - {V}_{k , i} ) + {a}_{i 0}^{k} ( {V}_{k , re} - {V}_{k , i} )\end{matrix} ,$$

where τ and \tilde{τ} are the lower-layer control times representing response speed. When aᵢⱼ>0, the i-th node can receive data from neighboring nodes; when aᵢ₀>0, the i-th node can receive data from the representative node.

S42. The voltage regulation algorithm between upper-layer microgrid clusters is as follows:

$$\{ \begin{matrix}T {\dot{V}}_{s , re} = {\sum }_{l ∈ {\tilde{N}}_{S}} {\tilde{a}}_{sl} ( {V}_{l , re} - {V}_{s , re} ) + {\tilde{a}}_{s 0} ( {V}^{rated} - {V}_{s , re} ) \\ \tilde{T} {\dot{V}}_{k , re} = {\sum }_{l ∈ {\tilde{N}}_{K}} {\tilde{a}}_{kl} ( {V}_{l , re} - {V}_{k , re} ) + {\tilde{a}}_{k 0} ( {V}^{rated} - {V}_{k , re} )\end{matrix} ,$$

where T and \tilde{T} are the upper-layer control times. When ãₛₗ>0/ãₖₗ>0, the s/k-th representative node in the s/k-th microgrid can receive data from neighboring nodes; when ãₛ₀>0/ãₖ₀>0, the s/k-th representative node can receive the rated value V^{rated} which is set from the virtual leader node.

Based on the hierarchical distributed control method for the microgrid cluster with heterogeneous batteries provided in this invention, the two-layer power management controller mentioned in S5 includes the followings.

S51. The two-layer economic operation control method for the microgrid cluster with the lithium battery includes the following.

The lower-layer power controller:

$$\begin{matrix}τ {\dot{P}}_{s , i}^{LB} = 2 {α}_{s , i}^{LB} {\dot{ϖ}}_{s , i}^{L B} \\ τ {\dot{ϖ}}_{s , i}^{LB} = {K}^{li} ( {\sum }_{j ∈ {N}_{s , i}} {a}_{ij}^{s} ( {ϖ}_{s , j}^{L B} - {ϖ}_{s , i}^{LB} ) + {a}_{i 0}^{s} ( {ϖ}_{re , s}^{L B} - {ϖ}_{s , i}^{LB} ) )\end{matrix} ,$$

where aᵢⱼ^{s} and aᵢⱼ^{s} represent the network link relations and leader node connection relations in the microgrid with the lithium battery.

The upper-layer power controller is as follows:

$$\begin{matrix}T {\dot{P}}_{re , s}^{LB} = 2 {α}_{re , s}^{LB} {\dot{ϖ}}_{re , s}^{L B} \\ T {\dot{ϖ}}_{re , s}^{LB} = {K}^{li , up} ( {\sum }_{l ∈ {\tilde{N}}_{s}} {a}_{sl}^{s} ( {ϖ}_{re , l}^{L B} - {ϖ}_{re , s}^{LB} ) + {a}_{s 0}^{li , up} ( {ϖ}_{re , k}^{VRB} - {ϖ}_{re , s}^{LB} ) )\end{matrix} ,$$

where aₛₗ^{s} represents the link relation of the upper-layer network.

S52. The two-layer economic operation control method for the microgrid cluster with the vanadium redox flow battery includes:

$$\begin{matrix}\tilde{τ} {\dot{P}}_{k , i}^{VRB} = - \frac{{E}_{VRB}^{rated}}{{a}_{VRB , c}} {\ddot{ϖ}}_{k , i}^{VRB} \\ \tilde{τ} {\dot{ϖ}}_{k , i}^{VRB} = {K}_{ϖ} {\sum }_{j ∈ Nk , i} {a}_{ij}^{k} ( {ϖ}_{k , j}^{VRB} - {ϖ}_{k , i}^{VRB} ) + {K}_{ϖ} {a}_{i 0}^{k} ( {ϖ}_{k , re}^{VRB} - {ϖ}_{k , i}^{VRB} ) \\ \tilde{T} {\dot{P}}_{re , k}^{VRB} = - \frac{{E}_{VRB}^{rated}}{{a}_{VRB , c}} {\ddot{ϖ}}_{re , k}^{VRB} \\ \tilde{T} {\dot{ϖ}}_{re , k}^{VRB} = {\sum }_{l ∈ \tilde{N} k , i} {a}_{ij}^{k} ( {ϖ}_{re , l}^{VRB} - {ϖ}_{re , k}^{VRB} )\end{matrix} .$$

According to the hierarchical distributed control method for the microgrid cluster with heterogeneous batteries provided by this invention, the design steps for the two-layer economic operation control algorithm for the microgrid cluster with the lithium battery include the following.

S511. Considering the cost function of the lithium battery, whose charging efficiency is related to output power, the cost function for operating can be represented by a traditional quadratic cost function as:

$${f}_{s , i}^{LB} ( {P}_{s , i}^{LB} ) = {( {α}_{s , i}^{LB} {P}_{s , i}^{LB} )}^{2} + {β}_{s , i}^{LB} {P}_{s , i}^{LB} + {c}_{s , i}^{LB} \\ {f}_{re , s}^{LB} ( {P}_{re , s}^{LB} ) = {( {α}_{re , s}^{LB} {P}_{re , s}^{LB} )}^{2} + {β}_{re , s}^{LB} {P}_{re , s}^{LB} + {c}_{re , s}^{LB} ,$$

where α_{s,i}>β_{s,i}, c_{s,i}, α_{re,s}, β_{re,s}, and c_{re,s} are the charging fitting coefficients for the i-th battery in the lower-layer network and the s-th representative battery in the upper-layer network.

S512. The proposed two-layer power management control method aims to minimize the total operating cost, and the control objective is:

$$\begin{matrix}\{ \begin{matrix}min {\sum }_{i = 1}^{n} {f}_{s , i}^{LB} ( {P}_{s , i}^{LB} ) \\ min {\sum }_{i = 1}^{S} {f}_{re , s}^{LB} ( {P}_{re , s}^{LB} )\end{matrix} \\ s . t . {\sum }_{i = 1}^{n} {P}_{s , i}^{LB} = {\sum }_{i = 1}^{n} {P}_{s , i}^{G} - {\sum }_{i = 1}^{n} {P}_{s , i}^{L} = {P}_{D , ic}^{LB} \\ s . t . {\sum }_{s = 1}^{S} {P}_{re , s}^{LB} = {P}_{D , re}^{LB} \\ \{ \begin{matrix}{P}_{s , i}^{LB} = 0 , & if {SoC}_{s , i}^{LB} ∉ [ \underline{{SoC}_{s , i}^{LB}} , \overline{{SoC}_{s , i}^{LB}} ] \\ {P}_{s , i}^{LB} ∈ [ \underline{{P}_{s , i}^{LB}} , \overline{{P}_{s , i}^{LB}} ] , & else\end{matrix} \\ \{ \begin{matrix}{P}_{re , s}^{LB} = 0 , & if {SoC}_{re , s}^{LB} ∉ [ \underline{{SoC}_{re , s}^{LB}} , \overline{{SoC}_{re , s}^{LB}} ] \\ {P}_{re , s}^{LB} ∈ [ \underline{{P}_{re , s}^{LB}} , \overline{{P}_{re , s}^{LB}} ] , & else\end{matrix}\end{matrix} ,$$

where P_{D,lo}^{LB} and P_{D,re}^{LB} are the load power of the upper-layer network and the load power of the lower-layer network, respectively; P_{s,i}^{LB},P̅_̅{̅s̅,̅i̅}̅^̅{̅L̅B̅}̅ and SoC_{s,i}^{LB},S̅o̅C̅_̅{̅s̅,̅i̅}̅^̅{̅L̅B̅}̅ are the minimum/maximum output power and the minimum/maximum SoC of the i-th battery in the s-th microgrid, respectively; P_{re,s}^{LB},P̅_̅{̅r̅e̅,̅s̅}̅^̅{̅L̅B̅}̅ and SoC_{re,s}^{LB},S̅o̅C̅_̅{̅r̅e̅,̅s̅}̅^̅{̅L̅B̅}̅ are the minimum/maximum output power and the minimum/maximum SoC of the battery in the s-th representative node, respectively.

S513. The Karush-Kuhn-Tucker conditions for the cost function for operating are:

$$\{ \begin{matrix}\frac{\partial {F}_{Lag} ( {P}_{s , i}^{LB} )}{\partial {P}_{s , i}^{LB}} = \frac{\partial {f}_{s , i}^{LB} ( {P}_{s , i}^{LB} )}{\partial {P}_{s , i}^{LB}} - {ϖ}_{s , i}^{LB} = 2 {α}_{s , i}^{LB} {P}_{s , i}^{LB} + {β}_{s , i}^{LB} - {ϖ}_{s , i}^{LB} = 0 \\ \frac{\partial {F}_{Lag} ( {P}_{re , s}^{LB} )}{\partial {P}_{re , s}^{LB}} = \frac{\partial {f}_{re , s}^{LB} ( {P}_{re , s}^{LB} )}{\partial {P}_{re , s}^{LB}} - {ϖ}_{re , s}^{LB} = 2 {α}_{re , s}^{LB} {P}_{re , s}^{LB} + {β}_{re , s}^{LB} - {ϖ}_{re , s}^{LB} = 0\end{matrix} .$$

S514. The optimal solution can be obtained as follows:

$$\begin{matrix}\{ \begin{matrix}{s , i}_{LB}^{} = 2 {α}_{s , i}^{LB} {P}_{s , i}^{LB} + {β}_{s , i}^{LB} , & as & {P}_{s , i}^{LB} ∈ [ \underline{{P}_{s , i}^{LB}} , \overline{{P}_{s , i}^{LB}} ] \\ {s , i}_{LB}^{} = 2 {α}_{s , i}^{LB} \underline{{P}_{s , i}^{LB}} + {β}_{s , i}^{LB} , & as & {P}_{s , i}^{LB} = \underline{{P}_{s , i}^{LB}} \\ {s , i}_{LB}^{} = 2 {α}_{s , i}^{LB} \overline{{P}_{s , i}^{LB}} + {β}_{s , i}^{LB} , & as & {P}_{s , i}^{LB} = \overline{{P}_{s , i}^{LB}}\end{matrix} \\ \{ \begin{matrix}{re , s}_{LB}^{} = 2 {α}_{re , s}^{LB} {P}_{re , s}^{LB} + {β}_{re , s}^{LB} , & as & {P}_{re , s}^{LB} ∈ [ \underline{{P}_{re , s}^{LB}} , \overline{{P}_{re , s}^{LB}} ] \\ {re , s}_{LB}^{} = 2 {α}_{re , s}^{LB} \underline{{P}_{re , s}^{LB}} + {β}_{re , s}^{LB} , & as & {P}_{re , s}^{LB} = \underline{{P}_{re , s}^{LB}} \\ {re , s}_{LB}^{} = 2 {α}_{re , s}^{LB} \overline{{P}_{re , s}^{LB}} + {β}_{re , s}^{LB} , & as & {P}_{re , s}^{LB} = \overline{{P}_{re , s}^{LB}}\end{matrix}\end{matrix} .$$

Based on the hierarchical distributed control method for the microgrid cluster with heterogeneous batteries provided by this invention, the design steps of the two-layer economic operation control algorithm for the microgrid cluster with the vanadium redox flow battery include the following.

S521. The cost function of the vanadium redox flow battery is determined by the SoC and the charging power, which can be expressed as:

$$f ( {P}_{k , i}^{VRB} ) = ( {a}_{VRB , c} {P}_{k , i}^{VRB} + {c}_{VRB , c} {P}_{VRB}^{rated} ) {SoC}_{k , i}^{VRB} + {b}_{VRB , c} {P}_{k , i}^{VRB} + {d}_{VRB} {P}_{VRB}^{rated} ,$$

where p_{VRB}^{rated} represents the charging power of the vanadium redox flow battery, SoC_{k,i}^{VRB} represents its state of charge (SOC), P_{VRB}^{rated} is its rated charging power, a_{VRB,c}, b_{VRB,c}, c_{VRB,c}, and d_{VRB,c} are charging efficiency parameters obtained through a nonlinear least squares regression method.

S522. The control objective of the two-layer power management control algorithm for the vanadium redox flow battery in the microgrid cluster is:

$$\{ \begin{matrix}min {\sum }_{i = 1}^{n} {f}_{k , i}^{VRB} ( {P}_{k , i}^{VRB} ) \\ min {\sum }_{k = 1}^{K} {f}_{re , k}^{VRB} ( {P}_{re , k}^{VRB} )\end{matrix}$$

$$s . t . {\sum }_{i = 1}^{n} {P}_{k , i}^{VRB} = {\sum }_{i = 1}^{n} {P}_{k , i}^{G} - {\sum }_{i = 1}^{n} {P}_{k , i}^{L} = {P}_{D , Jo}$$

$$s . t . {\sum }_{k = 1}^{K} {P}_{re , k}^{VRB} = {P}_{D , re}^{VRB}$$

$$\{ \begin{matrix}{P}_{k , i}^{VRB} = 0 , & if {SoC}_{k , i}^{VRB} ∉ [ \underline{{SoC}_{k , i}^{VRB}} , \overline{{SoC}_{k , i}^{VRB}} ] \\ {P}_{k , i}^{VRB} ∈ [ \underline{{P}_{k , i}^{VRB}} , \overline{{P}_{k , i}^{VRB}} ] , & else\end{matrix}$$

$$\{ \begin{matrix}{P}_{re , k}^{VRB} = 0 , & if {SoC}_{re , k}^{VRB} ∉ [ \underline{{SoC}_{re , k}^{VRB}} , \overline{{SoC}_{re , k}^{VRB}} ] \\ {P}_{re , k}^{VRB} ∈ [ \underline{{P}_{re , k}^{VRB}} , \overline{{P}_{re , k}^{VRB}} ] , & else\end{matrix}$$

where P_{D,lo}^{VRB} and P_{D,re}^{VRB} represent the load powers of the two-layer network in the microgrid cluster with vanadium redox flow battery, P_{k,i}^{VRB},P̅_̅{̅k̅,̅i̅}̅^̅{̅V̅R̅B̅}̅ and SoC_{k,i}^{VRB},S̅o̅C̅_̅{̅k̅,̅i̅}̅^̅{̅V̅R̅B̅}̅ are the minimum/maximum output power and the minimum/maximum SoC of the i-th battery in the k-th microgrid, while P_{re,k}^{VRB},P̅_̅{̅r̅e̅,̅k̅}̅^̅{̅V̅R̅B̅}̅ and SoC_{re,k}^{VRB},S̅o̅C̅_̅{̅r̅e̅,̅k̅}̅^̅{̅V̅R̅B̅}̅ are the minimum/maximum output power and the minimum/maximum SoC of the k-th battery in the representative node.

S523. The KKT conditions for the vanadium redox flow battery are:

$$\{ \begin{matrix}\begin{matrix}\frac{\partial {F}_{Lag} ( {P}_{k , i}^{VRB} )}{\partial {P}_{k , i}^{VRB}} = \frac{\partial {f}_{k , i}^{VRB} ( {P}_{k , i}^{VRB} )}{\partial {P}_{k , i}^{VRB}} - \\ {k , i}_{VRB}^{} = {a}_{VRB , c} {SoC}_{k , i}^{VRB} + {b}_{VRB , c} - {k , i}_{VRB}^{} = 0\end{matrix} \\ \begin{matrix}\frac{\partial {F}_{Lag} ( {P}_{re , k}^{VRB} )}{\partial {P}_{re , k}^{VRB}} = \frac{\partial {f}_{re , k}^{VRB} ( {P}_{re , k}^{VRB} )}{\partial {P}_{re , k}^{VRB}} - \\ {re , s}_{LB}^{} = {a}_{VRB , c} {SoC}_{re , k}^{VRB} + {b}_{VRB , c} - {re , k}_{VRB}^{} = 0\end{matrix}\end{matrix} .$$

S524. The optimal solution can be obtained as:

$$\{ \begin{matrix}{k , i}_{VRB}^{} = {a}_{VRB , c} {SoC}_{k , i}^{VRB} + {b}_{VRB , c} , & as & {SoC}_{k , i}^{VRB} ∈ [ \underline{{SoC}_{k , i}^{VRB}} , \overline{{SoC}_{k , i}^{VRB}} ] \\ {k , i}_{VRB}^{} = {a}_{VRB , c} \underline{{SoC}_{k , i}^{VRB}} + {b}_{VRB , c} , & as & {SoC}_{k , i}^{VRB} = \underline{{SoC}_{k , i}^{VRB}} \\ {k , i}_{VRB}^{} = {a}_{VRB , c} \overline{{SoC}_{k , i}^{VRB}} + {b}_{VRB , c} , & as & {SoC}_{k , i}^{VRB} = \overline{{SoC}_{k , i}^{VRB}}\end{matrix}$$

$$\{ \begin{matrix}{re , k}_{VRB}^{} = {a}_{VRB , c} {SoC}_{re , k}^{VRB} + {b}_{VRB , c} , & as & {SoC}_{re , k}^{VRB} ∈ [ \underline{{SoC}_{re , k}^{VRB}} , \overline{{SoC}_{re , k}^{VRB}} ] \\ {re , k}_{VRB}^{} = {a}_{VRB , c} \underline{{SoC}_{re , k}^{VRB}} + {b}_{VRB , c} , & as & {SoC}_{re , k}^{VRB} = \underline{{SoC}_{re , k}^{VRB}} \\ {re , k}_{VRB}^{} = {a}_{VRB , c} \overline{{SoC}_{re , k}^{VRB}} + {b}_{VRB , c} , & as & {SoC}_{re , k}^{VRB} = \overline{{SoC}_{re , k}^{VRB}}\end{matrix} .$$

The invention provides an electronic device, comprising a memory, a processor and a computer program stored on the memory which can operable on the processor. The processor is capable of executing programs to implement any of the above hierarchical distributed control methods for microgrid clusters with heterogeneous batteries.

The present invention provides a non-transitory computer-readable medium storing a program that causes a processor to implement any of the above hierarchical distributed control methods for microgrid clusters with heterogeneous batteries.

Compared with existing technologies, the present invention proposes a hierarchical distributed control framework to reduce the operational losses of different batteries in a microgrid cluster, while meeting the economic power sharing requirements within each microgrid, achieving economic power management between different microgrid clusters, and solving voltage regulation and power allocation problems within subnets and between microgrid clusters under communication delay interference.

Meanwhile, to solve the control problem of microgrid systems containing different types of batteries, the present invention physically defines the incremental cost of heterogeneous batteries as the partial derivative of battery energy loss with respect to output power, and proposes a cooperative control method for incremental cost of heterogeneous multiple battery cells, which can achieve economic power sharing among multiple heterogeneous battery cells while satisfying charging/discharging power constraints, SoC constraints, and power balance constraints. In addition, the method of combining heterogeneous batteries proposed by the present invention has scalability.

### BRIEF DESCRIPTION OF THE DRAWINGS

To clearly illustrate the technical solution of the present invention, a brief introduction will be given to the images required for the cases. For those skilled in the art, other drawings can be obtained based on these drawings without creative labor.

FIG. 1 is a two-layer control structure diagram of heterogeneous batteries in DC microgrid clusters provided by the present invention.

FIG. 2 is a two-layer system diagram of the heterogeneous battery system provided by the present invention.

FIG. 3A is a physical structure diagram of the two-layer structure provided by the present invention.

FIG. 3B is a two-layer communication network diagram provided by the present invention.

FIG. 4A is a schematic diagram of incremental cost variables in the mode switching case of the present invention.

FIG. 4B is a schematic diagram of SoC variables in the mode switching case of the present invention.

FIG. 4C is a schematic diagram of the charging power variable in the mode switching case of the present invention.

FIG. 4D is a schematic diagram of node voltage variables in the mode switching case of the present invention.

FIG. 5A is a schematic diagram of incremental cost variables in the load changes case of the present invention.

FIG. 5B is a schematic diagram of SoC variables in the load changes case of the present invention.

FIG. 5C is a schematic diagram of the charging power variable in the load changes case of the present invention.

FIG. 5D is a schematic diagram of node voltage variables in the load changes case of the present invention.

FIG. 6A is a schematic diagram of incremental cost variables in the plug and play case of the present invention.

FIG. 6B is a schematic diagram of SoC variables in the plug and play case of the present invention.

FIG. 6C is a schematic diagram of the charging power variable in the plug and play case of the present invention.

FIG. 6D is a schematic diagram of the voltage variable in the plug and play case of the present invention.

FIG. 7A is a schematic diagram of incremental cost variables in the communication delay case of the present invention.

FIG. 7B is a schematic diagram of SoC variables in the communication delay case of the present invention.

FIG. 7C is a schematic diagram of the charging power variable in the communication delay case of the present invention.

FIG. 7D is a schematic diagram of node voltage variables in the communication delay case of the present invention.

FIG. 8 is a schematic diagram of the electronic device structure provided by the present invention.

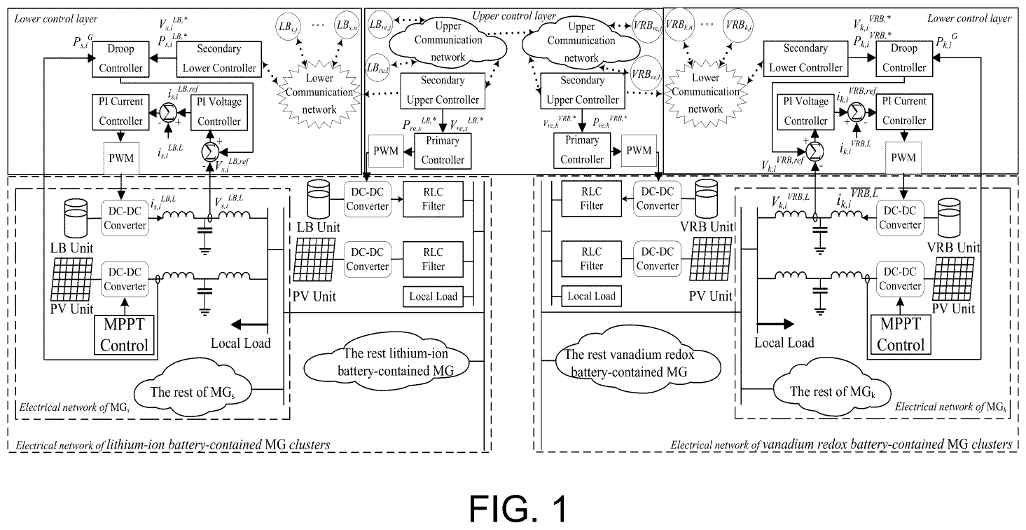

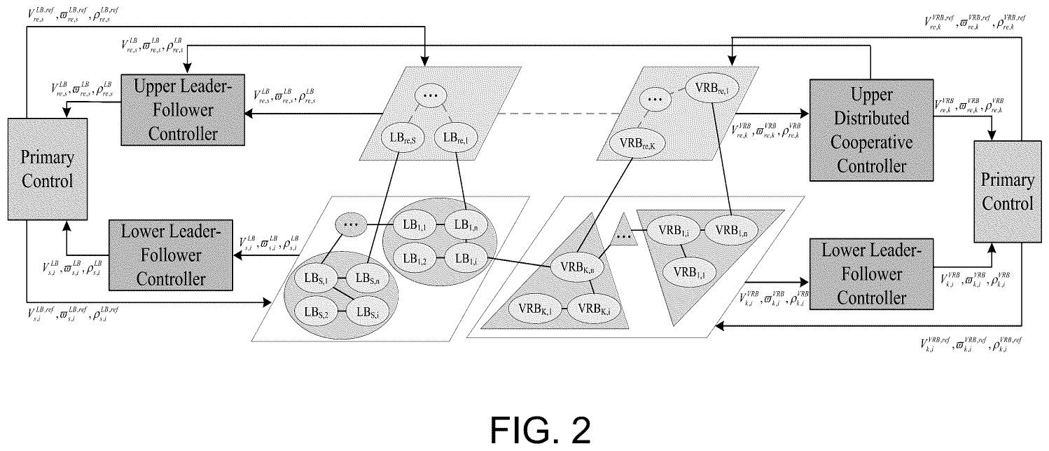

### DESCRIPTION OF THE EMBODIMENTS

### Specific Implementation Method

The technical solution of the present invention will be described clearly and completely in conjunction with the accompanying drawings. Obviously, the described cases are a part of the cases of the present invention, not all of them. Based on the cases of the present invention, all other cases obtained by skilled persons in the art without creative labor are within the scope of protection of the present invention.

This case is the hierarchical distributed control method for the microgrid cluster with heterogeneous batteries, which includes a hierarchical distributed control framework for microgrids. The structure comprises primary droop control, two-layer voltage regulation control, and two-layer power management control. It can address voltage regulation issues within subnets and between microgrid clusters, as well as the economic power distribution among multiple heterogeneous batteries.

Secondly, the incremental cost of heterogeneous batteries is physically unified as the partial derivative of the battery's energy loss with respect to output power. A cooperative control method for the incremental cost of multiple heterogeneous battery units is proposed, allowing economical power distribution among various units while satisfying charging/discharging power constraints, SoC constraints, and power balance constraints.

Finally, the proposed method combines battery types with charging efficiency related to charging power (e.g., lithium batteries) and battery types with charging efficiency related to SoC (e.g., vanadium flow batteries), which makes it easily scalable. Even when a new type of battery is adopted in the microgrid cluster, the proposed method remains effective.

### Case 1

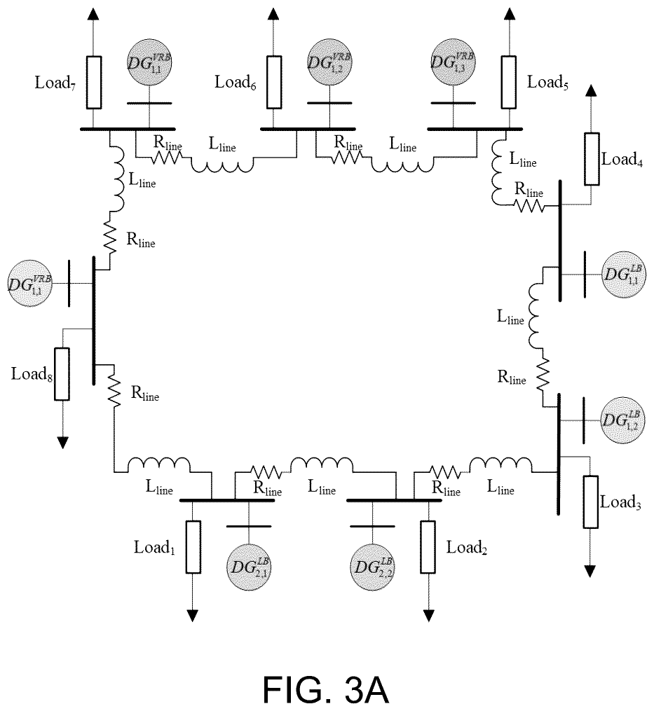

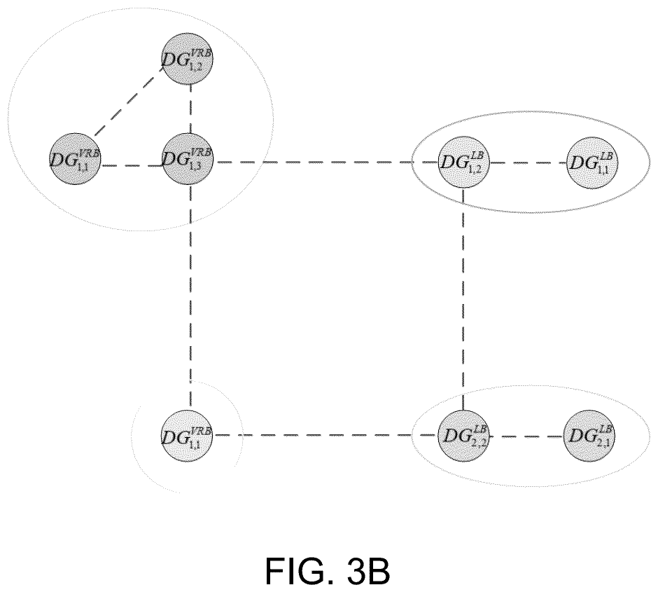

Case 1 simulates several DC microgrid clusters containing lithium-ion and vanadium flow batteries. The physical structure and communication links of the heterogeneous batteries within the microgrid clusters are shown in FIGS. 3A and 3B, and the parameters of the two-layer structure are given in Tables 1 and 2.

The lithium-ion battery microgrid MG₁^{LB} contains nodes DG_{1,1}^{LB} and DG_{1,2}^{LB}, while MG₂^{LB} contains nodes DG_{2,1}^{LB} and DG_{2,2}^{LB}. The vanadium flow battery microgrid MG₁^{VRB} contains nodes DG_{1,1}^{VRB}, DG_{1,2}^{VRB}, and DG_{1,3}^{VRB}, while MG₂^{VRB} includes node DG_{2,1}^{VRB}.

In the two-layer control structure, the lithium-ion battery nodes DG_{1,2}^{LB} and DGLB_{2,2}^{LB}, and the vanadium flow battery nodes DG_{1,3}^{VRB} and DG_{2,1}^{VRB} are selected as representative nodes. The state of DG_{1,1}^{LB} can follow the state of DG_{1,2}^{LB}, and the state of DG_{2,1}^{LB} can follow the state of DG_{1,2}^{LB}.

In the vanadium flow battery microgrid, DG_{1,1}^{VRB} and DG_{1,2}^{VRB} can follow the state of DG_{1,3}^{VRB}.

Moreover, the leadership adjacency matrix is defined as B^{S}=diag{1,0,1,0}, B^{K}=diag{1,1,0,1}, \tilde{B}_{S}=diag{1,1}, while the rest of the adjacency matrices are designed as
A^{S}=[0,1,0,0; 1,0,0,0; 0,0,0,1; 0,0,1,0],
A^{K}=[0,1,1,0; 1,0,1,0; 1,1,0,0; 0,0,0,0],
Ã^{S}=Ã^{K}=[0,1; 1,0].

The corresponding eigenvalues of the matrices are λₘₐₓ[(\tilde{L}^{S}+\tilde{B}^{S})⊗Iₙ]²]=9, λₘᵢₙ[(L̅^{S}+B̅^{S})⊗Iₙ]=1, λₘₐₓ(L̅^{S}+B̅^{S})=3, λₘₐₓ(L̅^{K}+B̅^{K})=3, λₘᵢₙ(L^{K}+B^{K})=0.382, λₘᵢₙ(L^{S}+B^{S})=0.382, λ₂(\tilde{L}^{K}⊗Iₙ)=2, λₘₐₓ[(\tilde{L}^{K}⊗Iₙ)²]=4.

Additionally, this example sets the control time coefficients of the lithium-ion battery microgrid clusters to T=0.2, T=10, and those of the vanadium flow battery microgrid clusters to \tilde{τ}=0.3, \tilde{T}=20, yielding ψ^{V}=ψ_{S}^{V}=ψ_{K}^{V}=0.5093, which clearly meets the control time constant ratio constraints

$$\frac{τ}{T} < {ψ}^{V} and \frac{\tilde{τ}}{\tilde{T}} < {ψ}^{V} ,$$

while ensures voltage regulation in the two-layer structure.

The control gain coefficients are set as K^{li}=3, K^{li,up}=0.8, K^{van}=1, K^{van,up}=0.5. Therefore.

$$max \{ \frac{{{T}^{2} + {( {K}^{li , up} )}^{2} {λ}_{max} [ [ {\tilde{L}}^{S} + {\tilde{B}}^{S} ) ⊗ {I}_{n} ]}^{2} ]}{2 {TK}^{li , up} {λ}_{max} [ [ {\tilde{L}}^{S} + {\tilde{B}}^{S} ) ⊗ {I}_{n} ]} ,$$

$$\frac{\tilde{τ}}{2 {K}^{van} {λ}_{min} ( {L}^{K} + {B}^{K} )} = 6.61 ,$$

$$min \{ \frac{2}{τ} {K}^{li} {λ}_{min} ( {L}^{K} + {B}^{K} ) ,$$

$$\frac{{\tilde{T}}^{2} {λ}_{2} ( {\tilde{L}}^{K} ⊗ {I}_{n} )}{{K}^{van , up} {{λ}_{max} ( {\tilde{L}}^{K} ⊗ {I}_{n} )}^{2}} = 11.459 are obtained .$$

Therefore, in this case, the condition coefficient is set to γ=8 ensure the stability of the control system.

TABLE 1
Parameters of microgrid with lithium battery

| Parameters | Symbol | Value | |
|---|---|---|---|
| Nominal Voltage | V* | 300 | V |
| Charge Power | p_{B, i}⁰ | {1.88, 2.98, 1.8, 2.55}KW | |
| Droop Parameter | Dᵢ | {0.25, 0.28, 0.22, 0.5} | |
| Charge Parameter | α | 0.038 | |
| Charge Parameter | β | 0.118 | |
| Line Resistance | Rₗᵢₙₑ | 0.05Ω | |
| Line Inductance | Lₗᵢₙₑ | 15 | mH |
| Battery Nominal Power | P_{VRB}^{rated} | 1.5 | kW |
| Battery Capacity | E_{LB}^{rated} | 20 | kWh |

| | | |
|---|---|---|
| Charging Power | [P_{LB, i}, | [0.5 kW, 5 kW] |
| Limitation | P̅_̅{̅L̅B̅,̅ i̅}̅] | |

TABLE 2
Parameters of microgrid with vanadium flow battery

| Parameters | Symbol | Value | |
|---|---|---|---|
| Nominal Voltage | V* | 300 | V |
| Charge Power | P_{B, i}⁰ | {5.11, 5.10, 7.12, 3.2}KW | |
| Droop Parameter | Dᵢ | {0.23, 0.27, 0.25, 0.52} | |
| Charge Parameter | a_{c}, b_{c}, c_{c}, d_{c} | −0.128, 1.05, 0.038, 0.118 | |
| Line Resistance | Rₗᵢₙₑ | 0.01Ω | |
| Line Inductance | Lₗᵢₙₑ | 5 | mH |
| Battery Nominal Power | P_{VRB}^{rated} | 5 | kW |
| Battery Capacity | E_{LB}^{rated} | 50 | kWh |

| | | |
|---|---|---|
| SoC Limitation | [SoCᵢ, S̅o̅C̅ᵢ̅] | [0.2, 0.8] |
| Charging Power | [P_{VRB, i}, P̅_̅{̅V̅R̅B̅,̅ i̅}̅] | [1 kW, 10 kW] |
| Limitation | | |

### Case 2

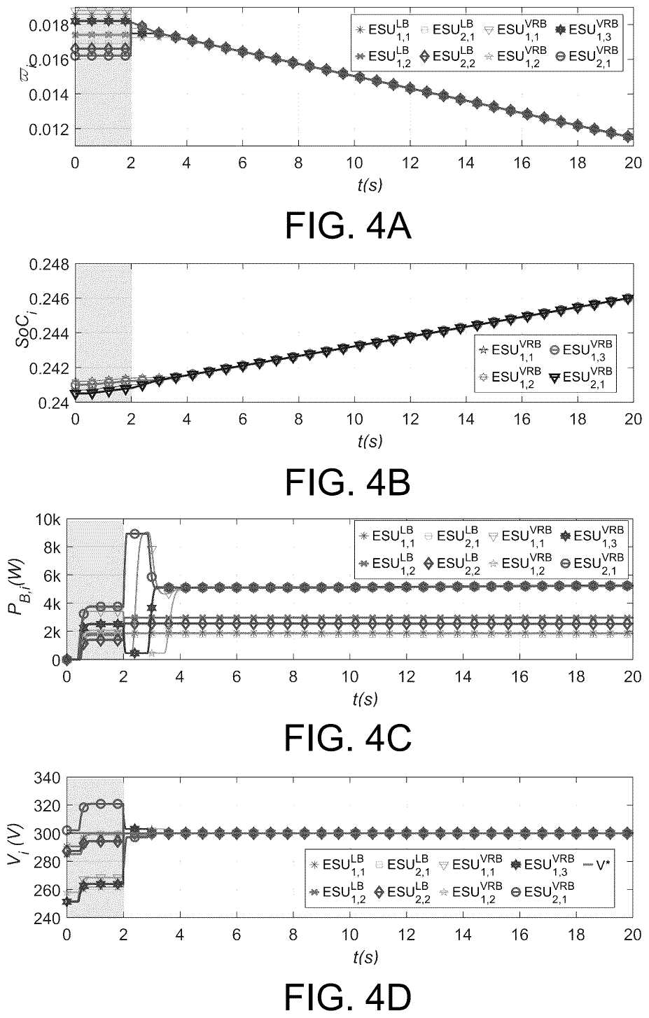

When switching from islanded mode to grid-connected mode, the control process is divided into two parts as shown in FIGS. 4A, 4B, 4C, and 4D.

In the initial staget ∈[0,0.2)s, eight nodes including distributed generation units with batteries operate in islanded mode, and their incremental costs, SoC, charging power, and voltage do not interact with each other. Then, the islanded DC microgrid cluster system can be connected to the grid at t=0.2s.

In the second part t∈[0.2,2)s, by adding a lower layer controller, eight nodes including distributed generation units with batteries are formed into four independent microgrids. Therefore, incremental cost consistency, SoC coordination, economical charging power allocation, and voltage regulation can be achieved within each microgrid. At the same time, the upper layer controller can achieve state interaction between microgrids containing different batteries, coordinate incremental costs, balance SoC, allocate charging power, and eliminate voltage deviations.

During the control process of microgrid with the lithium-ion battery, the follower controllers in DG_{1,1}^{LB} and DG_{2,1}^{LB} can follow the leader controllers in DG_{1,2}^{LB} and DG_{2,2}^{LB}. Meanwhile, the representative nodes DG_{1,2}^{LB} and DG_{2,2}^{LB} can coordinate the state of microgrid cluster with the lithium-ion battery by exchanging information and receiving external reference data. Similarly, in microgrid cluster with the vanadium flow battery, the incremental cost, SoC, and node voltage of DG_{1,1}^{VRB} and DG_{1,2}^{VRB} can be controlled to match the corresponding parameters of DG_{1,3}^{VRB}.

Moreover, microgrid cluster with the vanadium flow battery applies a distributed cooperative control method, whereas microgrid cluster with the lithium-ion battery implements a leader-follower control method at the upper control layer. It is worth noting that the leader defined in microgrid cluster with the lithium-ion battery essentially acquires steady-state information from microgrid cluster with the vanadium flow battery. Subsequently, by applying power balance constraints within microgrid cluster with the hybrid battery, the designed algorithm can achieve voltage regulation and economic power management.

### Case 3

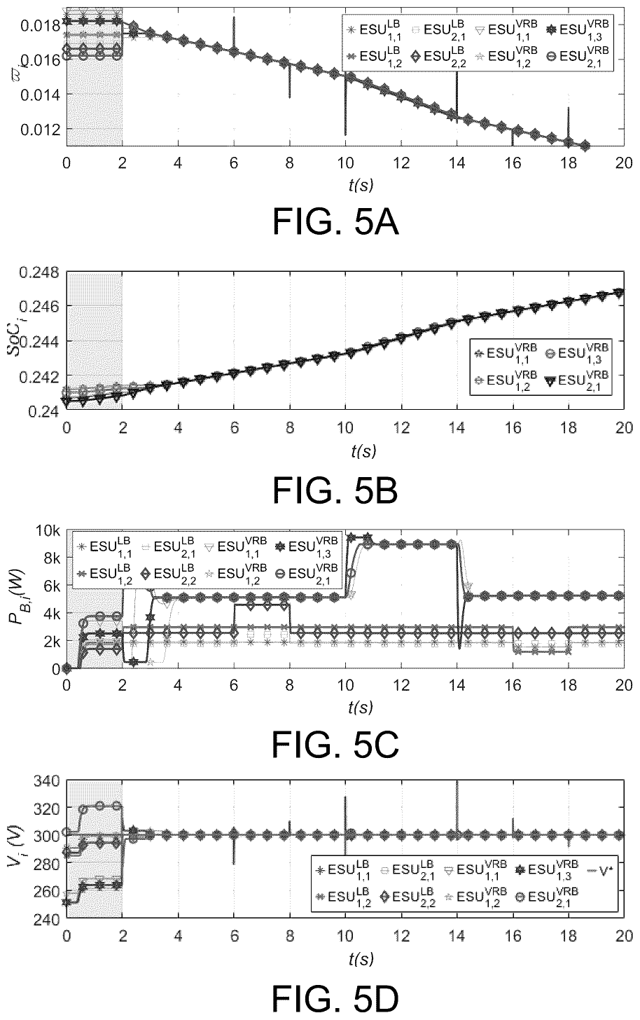

In this case, a 2.5 k W load Load_{2,2}^{LB} is removed from node DG_{2,2}^{LB} when t∈[0.6,0.8)s and re-added at t=0.8s. Furthermore, a 15 kW load Load_{1,3}^{VRB} is removed from node DG_{1,3}^{VRB} at t=1s and re-added at t=1.4s. After networking at t=0.2s, FIG. 5A demonstrates that the incremental costs of all battery units can converge to a common value. Load variations in microgrid cluster with the vanadium flow battery will affect the SoC increase rate of each battery, as depicted in FIG. 5B.

FIG. 5C shows the charging power of all batteries. In a single microgrid, the state of representative node DG_{1,2&2,2}^{LB} influences the state of non-representative nodes, while non-representative nodes DG_{1,1&2,1}^{LB} perform power allocation through information exchange to achieve power balance. At t=0.6s, the removal of the 2.5 kW load from node DG_{2,2}^{LB} increases the charging power of each lithium battery node. After the load is re-added at t=0.8s, the charging power returns to its previous value. For microgrid cluster with the vanadium flow battery, a 15 kW load Load_{1,3}^{VRB} is removed from DG_{1,3}^{VRB} when t∈[1,1.4)s, and the charging power variation shown in FIG. 5C confirms the robustness of the invention under load fluctuations. Since the actual charging power follows the reference values provided by the controller, voltage fluctuations caused by load changes can be eliminated, and the system can re-enter a steady state, as shown in FIG. 5D.

### Case 4

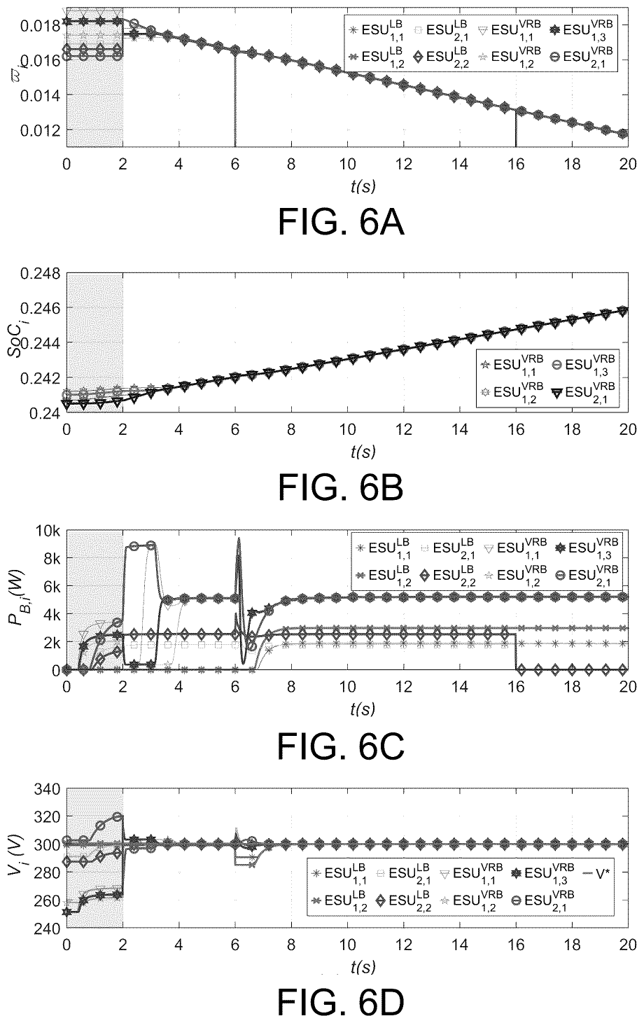

This case demonstrates the plug-and-play capability, as shown in FIGS. 6A, 6B, 6C, and 6D.

Six battery-equipped DG units form a microgrid at t=0.2s. At t=0.6s, a new microgrid MG₁^{LB} is added, disrupting the steady state of the original microgrid cluster composed of six battery-equipped DG units. At this point, the designed two-layer controller is applied to the system to mitigate the fluctuations caused by the plug operation, while coordinating incremental costs, balancing SoC, sharing charging power, and restoring the voltage. After a brief period of transient evolution, the system can return to a stable state.

The microgrid cluster MG₂^{LB} formed by DG_{2,1&2,2}^{LB} is cut off at t=1.6s, severing the physical link between MG₂^{LB} and the other microgrid clusters. However, after the disconnection of MG₂^{LB}, the remaining microgrid clusters MG₁^{LB}, MG₁^{VRB}, and MG₂^{VRB} can still realize economic power sharing and voltage regulation, demonstrating the plug-and-play capability of the proposed two-layer control structure.

### Case 5

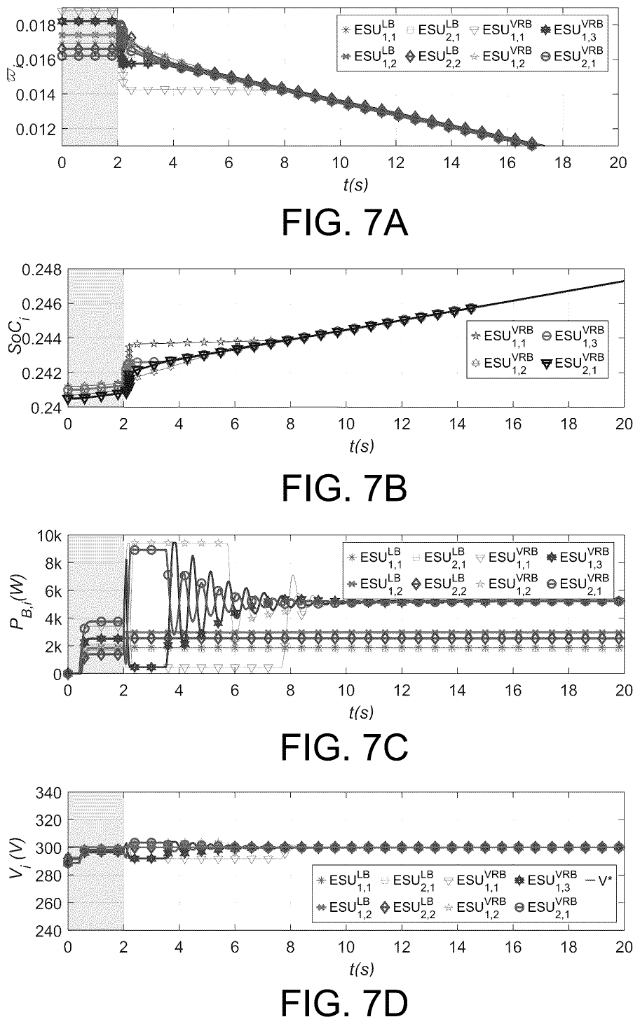

Variable communication delays 0.008 (sin(25t)+π/4)+0.022 exist in this case, as depicted in FIGS. 7A, 7B, 7C, and 7D. Due to the control time constraints between the microgrid clusters containing lithium batteries and those containing vanadium redox flow batteries, the two-layer control scheme of this invention is highly sensitive to system response speed. However, the sparse communication matrix can cover a wide range of low-bandwidth communication networks, providing robustness against delays in communication links. The impact is minimal, thus the system can still accomplish incremental cost alignment, SoC balancing, power distribution, and voltage regulation.

### Case 6

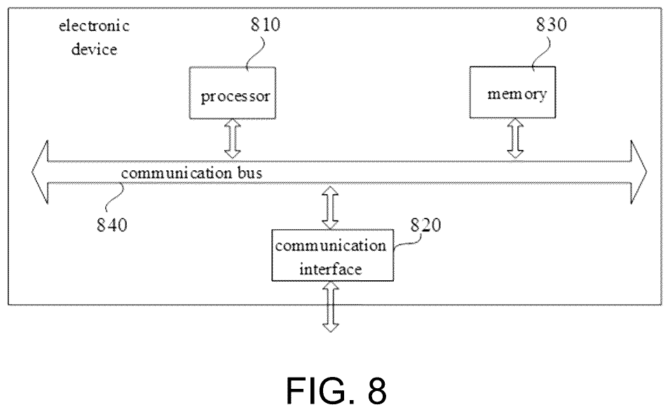

FIG. 8 illustrates a schematic diagram of the physical structure of an electronic device. The electronic device include a processor 810, a communications interface 820, memory 830, and a communications bus 840. The processor 810, communications interface 820, and memory 830 communicate with each other via the communications bus 840. The processor 810 can invoke logical instructions in memory 830 to execute the hierarchical distributed control method for microgrid clusters with heterogeneous batteries.

Furthermore, the logical instructions stored in memory 830 can be realized in the form of software functional units. The software can be stored in a computer-readable storage medium when sold or used independently. With this understanding, the technical solution of this invention, or the part contributing to existing technology, may be expressed as a software product. The computer software product is stored in a storage medium and includes several instructions for enabling a computer device (which can be a personal computer, server, or network device, etc.) to execute all or part of the steps of the methods described in various cases of the invention. The aforementioned storage media include: USB drives, portable hard drives, read-only memory (ROM), random access memory (RAM), magnetic disks, optical discs, and various other media capable of storing program code.

Furthermore, the present invention provides a non-transitory computer-readable medium storing a program that causes a processor to implement any of the above hierarchical distributed control methods for microgrid clusters with heterogeneous batteries.

The aforementioned device cases are only illustrative. The units described as separate components may or may not be physically separated, and the components presented as units may or may not be physical entities. They may be situated in one location or distributed across multiple network units. Parts or all of the modules can be selected according to actual needs to achieve the objectives of the case. Skilled persons in this field can understand and implement it without creative effort.

Based on the description of the above cases, those skilled in the art can readily understand that these cases can be realized by using software combined with the necessary general hardware platform, or through hardware. Naturally, hardware can also be employed. From this perspective, the essence of the above-mentioned technical solution, or the part contributing to existing technologies, can be embodied as a software product, which may be stored in computer-readable storage media, such as ROM (read-only memory)/RAM (random-access memory), magnetic disks, optical disks, etc., including a set of instructions for enabling a computer device (such as a personal computer, server, or network equipment) to perform the methods described in the cases or portions of them.

Finally, it should be clarified that the above cases serve merely to illustrate the technical solutions of the invention and are not intended to limit them. Although the invention has been described in detail with reference to the above cases, those skilled in the field should understand that they can still modify the technical solutions described in the previous cases, or make equivalent replacements of certain technical features. These modifications or replacements do not deviate from the spirit and scope of the technical solutions of the cases of the present invention.

What is claimed is:

1. A hierarchical distributed control method for a microgrid cluster with heterogeneous batteries, characterized by following steps:
establishing a two-layer control structure, which includes primary droop control, two-layer voltage regulation control, and two-layer power management control;
unifying a physical definition of incremental cost for heterogeneous battery units;
adopting P-V primary droop control to quickly track a nominal voltage of an i-th converter's output voltage;
using a two-layer voltage regulation controller; when a control time meets conditions 0<τ/T<ψ^{V} and 0<\tilde{τ}/\tilde{T}<ψ^{V}, a two-layer voltage regulation algorithm achieves following control objectives:
$$\begin{matrix}{lim}_{t \to ∞} \vert {V}_{s , i} ( t ) - {V}_{s , re} \vert = 0 , {lim}_{t \to ∞} \vert {V}_{k , i} ( t ) - {V}_{k , re} \vert = 0 \\ {lim}_{t \to ∞} \vert {V}_{s , re} ( t ) - {V}^{rated} \vert = 0 , {lim}_{t \to ∞} \vert {V}_{k , re} ( t ) - {V}^{rated} \vert = 0\end{matrix} ,$$
where τ and î are lower-layer control times that represent response speed, T and \tilde{T} are upper-layer control times, lithium battery is marked as s, and vanadium redox flow battery is marked as k; ψ^{V}=min{{ψ_{S}^{V}, ψ_{K}^{V}}, where
$${Ψ}_{S}^{V} {=}^{Δ} \frac{4 {λ}_{min} ( {L}^{S} + {B}^{2} )}{{λ}_{min} ( {\tilde{L}}^{S} + {\tilde{B}}^{2} )} and {Ψ}_{K}^{V} {=}^{Δ} \frac{4 {λ}_{min} ( {L}^{K} + {B}^{K} )}{{λ}_{min} ( {\tilde{L}}^{K} + {\tilde{B}}^{K} )}$$
are constants, and V^{rated} is a rated value;
by unifying the physical definition of the incremental cost for the heterogeneous battery units, a two-layer power management controller is obtained, a positive condition coefficient γ is established, and a two-layer power management control algorithm realizes following control objectives:
$$\begin{matrix}( i ) {lim}_{t \to ∞} \vert {s , i}_{LB}^{} ( t ) - {re , s}_{LB}^{} ( t ) \vert = 0 \\ ( ii ) {lim}_{t \to ∞} \vert {re , s}_{LB}^{} ( t ) - {re , k}_{VRB}^{} ( t ) \vert = 0\end{matrix} and \begin{matrix}( i ) {lim}_{t \to ∞} \vert {k , i}_{VRB}^{} ( t ) - {re , k}_{VRB}^{} ( t ) \vert = 0 \\ ( ii ) {lim}_{t \to ∞} \vert {re , k}_{VRB}^{} ( t ) - {re , l}_{VRB}^{} ( t ) \vert = 0\end{matrix} ,$$
where the lithium battery is marked as s, the vanadium redox flow battery is marked as k, and ω̅ represents the incremental cost.

2. The hierarchical distributed control method for the microgrid cluster with the heterogeneous batteries according to claim 1, wherein the two-layer control structure includes:
S11, all nodes in a microgrid cluster system are divided into representative nodes and non-representative nodes, wherein all representative nodes form a upper-layer control structure, and the non-representative nodes form a lower-layer control structure;
S12, the two-layer control structure selects representative nodes from each subnet for performing a distributed consensus control method via a upper-layer communication network \tilde{G}, while the other nodes in a lower layer perform a leader-follower control method via a communication network G to coordinate their own states;
S13, a lower-layer network of the two-layer control structure adopts the leader-follower control method to ensure that a stable state of each node is consistent with that of the representative node, achieving voltage restoration, incremental cost coordination, and power balance within an individual microgrid;
S14, an operation of a upper-layer network of the two-layer control structure has two situations: when an external node sends a reference state value to the upper-layer network, the upper-layer network adopts the leader-follower control method to ensure the stable state of the representative node equals the reference value; otherwise, the upper-layer network employs the distributed consensus control method to ensure the stable state of the representative node equals to an average of total initial values.

3. The hierarchical distributed control method for the microgrid cluster with the heterogeneous batteries according to claim 1, wherein the unified physical definition of the incremental cost for the heterogeneous battery units includes:
S21, for different types of batteries, an evaluation method of a state of charge (SoC) is expressed as:
$$S \dot{o} {C}_{i} = - {P}_{B , i} {η}_{B , i} / {E}_{B , i}^{rated} i ∈ {v}_{C} ,$$
where ν_{C} represents a set of converters connected to batteries in a direct current (DC) microgrid cluster, SoCᵢ, P_{B,i}, η_{B,i}, and E_{B,i}^{rated} represent the SoC, controllable charging power, charging efficiency, and rated capacity of an i-th battery, respectively;
S22, different types of the batteries have different charging efficiencies; the charging efficiencies of the lithium-ion battery and vanadium redox flow battery are expressed as:
$$\{ \begin{matrix}{η}_{B , i} = {α}_{i}^{LB} {P}_{B , i} + {β}_{i}^{LB} & lithium - ion battery \\ \begin{matrix}{η}_{B , i} = ( {α}^{VRB} {SoC}_{i}^{VRB} + {b}^{VRB} ) + \\ \frac{{P}_{B , i}^{rated}}{{P}_{B , i} ( t )} ( {c}^{VRB} {SoC}_{i}^{VRB} + {d}^{VRB} )\end{matrix} & vanadium redox flow battery\end{matrix}$$
S23, an optimization objective:
$$min f ( {P}_{B , i} ) = min {\sum }_{i = 1}^{N} {P}_{B , i} {η}_{B , i}$$
$$s . t . {\sum }_{i = 1}^{N} {P}_{B , i} = {\sum }_{i = 1}^{N} {P}_{G , i} - {\sum }_{i = 1}^{N} {P}_{L , i} ,$$
$$\{ \begin{matrix}{P}_{B , i} = 0 , & if {SOC}_{i} ∉ [ \underline{{SOC}_{i}} , \overline{{SoC}_{i}} ] \\ {P}_{B , i} ∈ [ \underline{{P}_{B , i}} , \overline{{P}_{B , i}} ] , & else\end{matrix} ,$$
where P_{L}=ΣP_{L,i} represents a total load demand, and ΣP_{G,i} is a total generation power;
S24, a Lagrange multiplier method is used for optimization, where the Lagrangian function is expressed as:
$${F}_{Lag} ( {P}_{B , i} ) = {\sum }_{i = 1}^{n} f ( {P}_{B , i} ) + {\sum }_{i = 1}^{n} {ϖ}_{i} ( {P}_{G , i} - {P}_{L , i} - {P}_{B , i} ) ,$$
and partial derivative is given:
$$\frac{\partial {F}_{Lag} ( {P}_{B , i} )}{\partial {P}_{B , i}} = \frac{\partial f ( {P}_{B , i} )}{\partial {P}_{B , i}} - {i}_{} ,$$
where [symbol] ᵢ is a Lagrange multiplier of the i-th battery, and economic operation is achieved by coordinated designing of Lagrange multipliers for different batteries, in a physical sense, [symbol] represents the incremental cost of the i-th battery, and the incremental cost for the heterogeneous batteries is the partial derivative of energy loss with respect to output power for each of the heterogeneous battery units.

4. The hierarchical distributed control method for the microgrid cluster with the heterogeneous batteries according to claim 1, wherein the P-V primary droop control includes:
S31, a voltage and power output expression for the P-V primary droop control is:
$${V}_{i} - {V}_{i}^{*} = {D}_{i} ( {P}_{i}^{*} - {P}_{i} ) , i ∈ {v}_{c} ,$$
where ν_{C} represents a set of converters connected to batteries in a DC microgrid cluster, Vᵢ and Dᵢ are an output voltage and a droop coefficient respectively, while Vᵢ and P*ᵢ represent the nominal voltage and a nominal active power respectively, an active power injection Pᵢ satisfies Pᵢ=P_{G,i}−P_{B,i}, wherein, P_{G,i} and P_{B,i} represent a generation power and a charging power of a battery respectively;
S32, a secondary control eliminates voltage deviation; it drives the charging power P_{B,i} to match a reference power P_{B,i}^{ref} generated by the secondary control, and the voltage deviation \hat{V}ᵢ=Vᵢ-V*ᵢ is restored to zero:
$${lim}_{t \to ∞} \vert {P}_{B , i} ( t ) - {P}_{B , i}^{ref} ( t ) \vert = 0 , i ∈ {v}_{c}$$
$${lim}_{t \to ∞} {\hat{V}}_{i} ( t ) = 0 , i ∈ {v}_{c} .$$

5. The hierarchical distributed control method for the microgrid cluster with the heterogeneous batteries according to claim 1, wherein the two-layer voltage regulation controller includes:
S41, a voltage regulation algorithm for a single microgrid MGₛ/MGₖ in a lower layer:
$$\{ \begin{matrix}τ {\dot{V}}_{s , i} = {\sum }_{j ∈ {N}_{s , i}} {a}_{ij}^{s} ( {V}_{s , j} - {V}_{s , i} ) + {a}_{i 0}^{s} ( {V}_{s , re} - {V}_{s , i} ) \\ τ {\dot{V}}_{k , i} = {\sum }_{j ∈ {N}_{k , i}} {a}_{ij}^{k} ( {V}_{k , j} - {V}_{k , i} ) + {a}_{i 0}^{k} ( {V}_{k , re} - {V}_{k , i} )\end{matrix} ,$$
where τ and \hat{τ} are lower-layer control times representing response speed, when aᵢⱼ>0, an i-th node receives data from neighboring nodes; when aᵢₒ>0, the i-th node receives data from a representative node;
S42, a voltage regulation algorithm among upper-layer microgrid clusters:
$$\{ \begin{matrix}T {\dot{V}}_{s , re} = {\sum }_{l ∈ {\tilde{N}}_{S}} {\tilde{a}}_{sl} ( {V}_{l , re} - {V}_{s , re} ) + {\tilde{a}}_{s 0} ( {V}^{rated} - {V}_{s , re} ) \\ \tilde{T} {\dot{V}}_{k , re} = {\sum }_{l ∈ {\tilde{N}}_{K}} {\tilde{a}}_{kl} ( {V}_{l , re} - {V}_{k , re} ) + {\tilde{a}}_{k 0} ( {V}^{rated} - {V}_{k , re} )\end{matrix} ,$$
where T and \tilde{T} represent the upper-layer control times, when ãₛₗ>0/ãₖₗ>0, a s/k-th representative node in a s/k-th microgrid receives data from neighboring nodes; when ãₛ₀>0/ãₖ₀>0, the s/k-th representative node receives the rated value V^{rated} which is set from a virtual leader node.

6. The hierarchical distributed control method for the microgrid cluster with the heterogeneous batteries according to claim 1, wherein the two-layer power management controller includes:
S51, a two-layer economic operation control for the microgrid cluster with the lithium battery includes:
a lower-layer power controller:
$$τ {\dot{P}}_{s , i}^{LB} = 2 {α}_{s , i}^{LB} {s , i}_{LB}^{}$$
$$τ {s , i}_{LB}^{} = {K}^{li} ( {\sum }_{j ∈ Ns , i} {a}_{ij}^{s} ( {s , j}_{LB}^{} - {s , i}_{LB}^{} ) + {a}_{i 0}^{s} ( {re , s}_{LB}^{} - {s , i}_{LB}^{} ) ) ,$$
where aᵢⱼ^{s} and aᵢₒ^{s} represent network link relationships and leader node connection relationships in a microgrid with the lithium battery;
an upper-layer power controller:
$$T {\dot{P}}_{re , s}^{LB} = 2 {α}_{re , s}^{LB} {re , s}_{LB}^{}$$
$$T {re , s}_{LB}^{} = {K}^{li , up} ( {\sum }_{l ∈ \tilde{N} s} {a}_{sl}^{s} ( {re , l}_{LB}^{} - {re , s}_{LB}^{} ) + {a}_{s 0}^{li , up} ( {re , k}_{VRB}^{} - {re , s}_{LB}^{} ) ) ,$$
where aₛₗ^{s} represents a link relationship of an upper-layer network;
S52, a two-layer economic operation control for the microgrid cluster with the vanadium redox flow battery includes:
$$\tilde{τ} {\dot{P}}_{k , i}^{VRB} = - \frac{{E}_{VRB}^{rated}}{{a}_{VRB , c}} {k , i}_{VRB}^{}$$
$$\tilde{τ} {k , i}_{VRB}^{} = {\sum }_{j ∈ Nk , i} {a}_{ij}^{k} ( {k , j}_{VRB}^{} - {k , i}_{VRB}^{} ) + {a}_{i 0}^{k} ( {k , re}_{VRB}^{} - {k , i}_{VRB}^{} )$$
$$\tilde{T} {\dot{P}}_{re , k}^{VRB} = - \frac{{E}_{VRB}^{rated}}{{a}_{VRB , c}} {re , k}_{VRB}^{}$$
$$\tilde{T} {re , k}_{VRB}^{} = {\sum }_{l ∈ \tilde{N} k , i} {a}_{ij}^{k} ( {re , l}_{VRB}^{} - {re , k}_{VRB}^{} ) .$$

7. The hierarchical distributed control method for the microgrid cluster with the heterogeneous batteries according to claim 6, wherein an algorithm for the two-layer economic operation control for the microgrid cluster with the lithium battery in S51 includes:
S511, considering a cost function of the lithium battery, which have charging efficiency related to output power, the cost function for operating is represented by a traditional quadratic cost function as:
$${f}_{s , i}^{LB} ( {P}_{s , i}^{LB} ) = {( {α}_{s , i}^{LB} {P}_{s , i}^{LB} )}^{2} + {β}_{s , i}^{LB} {P}_{s , i}^{LB} + {c}_{s , i}^{LB}$$
$${f}_{re , s}^{LB} ( {P}_{re , s}^{LB} ) = {( {α}_{re , s}^{LB} {P}_{re , s}^{LB} )}^{2} + {β}_{re , s}^{LB} {P}_{re , s}^{LB} + {c}_{re , s}^{LB} ,$$
where a_{s,i}, β_{s,i}, c_{s,i}, α_{re,s}, β_{re,s}, and c_{re,s} are charging fitting coefficients for an i-th battery in a lower-layer network and a s-th representative battery in the upper-layer network;
S512, a control objective of a two-layer power management control method is defined as:
$$\{ \begin{matrix}min {\sum }_{i = 1}^{\text{?}} {f}_{s , i}^{LB} ( {P}_{s , i}^{LB} ) \\ min {\sum }_{i = 1}^{S} {f}_{re , s}^{LB} ( {P}_{re , s}^{LB} )\end{matrix}$$
$$s . t . {\sum }_{i = 1}^{n} {P}_{s , i}^{LB} = {\sum }_{i = 1}^{n} {P}_{s , i}^{G} - {\sum }_{i = 1}^{n} {P}_{s , i}^{L} = {P}_{D , lo}^{LB}$$
$$s . t . {\sum }_{s = 1}^{S} {P}_{re , s}^{LB} = {P}_{D , re}^{LB}$$
$$\{ \begin{matrix}{P}_{s , i}^{LB} = 0 , & if {SoC}_{s , i}^{LB} ∉ [ \underline{{SoC}_{s , i}^{LB}} , \overline{{SoC}_{s , i}^{LB}} ] \\ {P}_{s , i}^{LB} ∈ [ \underline{{P}_{s , i}^{LB}} , \overline{{P}_{s , i}^{LB}} ] , & else\end{matrix}$$
$$\{ \begin{matrix}{P}_{re , s}^{LB} = 0 , & if {SoC}_{re , s}^{LB} ∉ [ \underline{{SoC}_{re , s}^{LB}} , \overline{{SoC}_{re , s}^{LB}} ] \\ {P}_{re , s}^{LB} ∈ [ \underline{{P}_{re , s}^{LB}} , \overline{{P}_{re , s}^{LB}} ] , & else\end{matrix} ,$$
$$\text{?} \text{indicates text missing or illegible when filed}$$
where P_{D,lo}^{LB} and P_{D,re}^{LB} represent a load power of the upper-layer network and a load power of the lower-layer network respectively, P_{s,i}^{LB},P̅_̅{̅s̅,̅i̅}̅^̅{̅L̅B̅}̅ and SoC_{s,i}^{LB},S̅o̅C̅_̅{̅s̅,̅i̅}̅^̅{̅L̅B̅}̅ are a minimum/maximum output power and a minimum/maximum SoC of the i-th battery in a s-th microgrid respectively, while P_{re,s}^{LB},P̅_̅{̅r̅e̅,̅s̅}̅^̅{̅L̅B̅}̅ and SoC_{re,s}^{LB},S̅o̅C̅_̅{̅r̅e̅,̅s̅}̅^̅{̅L̅B̅}̅ are a minimum/maximum output power and a minimum/maximum SoC of the battery in a s-th representative node respectively;
S513, Karush-Kuhn-Tucker conditions for the cost function for operating are:
$$\{ \begin{matrix}\frac{\partial {F}_{Lag} ( {P}_{s , i}^{LB} )}{\partial {P}_{s , i}^{LB}} = \frac{\partial {f}_{s , i}^{LB} ( {P}_{s , i}^{LB} )}{\partial {P}_{s , i}^{LB}} - {s , i}_{LB}^{} = 2 {α}_{s , i}^{LB} {P}_{s , i}^{LB} + {β}_{s , i}^{LB} - {s , i}_{LB}^{} = 0 \\ \frac{\partial {F}_{Lag} ( {P}_{re , s}^{LB} )}{\partial {P}_{re , s}^{LB}} = \frac{\partial {f}_{re , s}^{LB} ( {P}_{re , s}^{LB} )}{\partial {P}_{re , s}^{LB}} - {re , s}_{LB}^{} = 2 {α}_{re , s}^{LB} {P}_{re , s}^{LB} + {β}_{re , s}^{LB} - {re , s}_{LB}^{} = 0\end{matrix} ,$$
S514, an optimal solution is:
$$\{ \begin{matrix}{\text{?}}_{LB}^{} = 2 {α}_{\text{?}}^{LB} {P}_{\text{?}}^{LB} + {β}_{\text{?}}^{LB} , & as & {P}_{\text{?}}^{LB} ∈ [ \underline{{P}_{\text{?}}^{LB}} , \overline{{P}_{\text{?}}^{LB}} ] \\ {\text{?}}_{LB}^{} = 2 {α}_{\text{?}}^{LB} \underline{{P}_{\text{?}}^{LB}} + {β}_{\text{?}}^{LB} , & as & {P}_{\text{?}}^{LB} = \underline{{P}_{\text{?}}^{LB}} \\ {\text{?}}_{LB}^{} = 2 {α}_{\text{?}}^{LB} \overline{{P}_{\text{?}}^{LB}} + {β}_{\text{?}}^{LB} , & as & {P}_{\text{?}}^{LB} = \overline{{P}_{\text{?}}^{LB}}\end{matrix}$$
$$\{ \begin{matrix}{re , s}_{LB}^{} = 2 {α}_{re , s}^{LB} {P}_{\text{?}}^{LB} + {β}_{re , s}^{LB} , & as & {P}_{re , s}^{LB} ∈ [ \underline{{P}_{re , s}^{LB}} , \overline{{P}_{re , s}^{LB}} ] \\ {re , s}_{LB}^{} = 2 {α}_{re , s}^{LB} \underline{{P}_{re , s}^{LB}} + {β}_{re , s}^{LB} , & as & {P}_{re , s}^{LB} = \underline{{P}_{re , s}^{LB}} , \\ {re , s}_{LB}^{} = 2 {α}_{re , s}^{LB} \overline{{P}_{re , s}^{LB}} + {β}_{re , s}^{LB} , & as & {P}_{\text{?}}^{LB} = \overline{{P}_{\text{?}}^{LB}}\end{matrix} .$$
$$\text{?} \text{indicates text missing or illegible when filed}$$

8. The hierarchical distributed control method for the microgrid cluster with the heterogeneous batteries according to claim 6, wherein an algorithm for the two-layer economic operation control for the microgrid cluster with the vanadium redox flow battery in S52 includes:
S521, considering a cost function of the vanadium redox flow battery, the cost function of the vanadium redox flow battery is expressed as:
$$f ( {P}_{k , i}^{VRB} ) = ( {a}_{VRB , c} {P}_{k , i}^{VRB} + {c}_{VRB , c} {P}_{VRB}^{rated} ) {SoC}_{k , i}^{VRB} + {b}_{VRB , c} {P}_{k , i}^{VRB} + {d}_{VRB , c} {P}_{VRB}^{rated} ,$$
where P_{k,i}^{VRB} is charging power of the vanadium redox flow battery, SoC_{k,i}^{VRB} represents a SoC, p_{VRB}^{rated} is a rated charging power, and a_{VRB,c}, b_{VRB,c}, c_{VRB,c}, and d_{VRB,c} are charging efficiency parameters obtained by a nonlinear least squares regression method;
S522, a control objective of a two-layer power management control algorithm for the vanadium redox flow battery in the microgrid cluster is:
$$\{ \begin{matrix}min {\sum }_{i = 1}^{n} {f}_{k , i}^{VRB} ( {P}_{k , i}^{VRB} ) \\ min {\sum }_{k = 1}^{K} {f}_{re , k}^{VRB} ( {P}_{re , k}^{VRB} )\end{matrix}$$
$$s . t . {\sum }_{i = 1}^{n} {P}_{k , i}^{VRB} = {\sum }_{i = 1}^{n} {P}_{s , i}^{G} - {\sum }_{i = 1}^{n} {P}_{k , i}^{L} = {P}_{D , lo}^{LB}$$
$$s . t . {\sum }_{s = 1}^{K} {P}_{re , k}^{VRB} = {P}_{D , re}^{VRB}$$
$$\{ \begin{matrix}{P}_{k , i}^{VRB} = 0 , & if {SoC}_{k , i}^{VRB} ∉ [ \underline{{SoC}_{k , i}^{VRB}} , \overline{{SoC}_{\text{?}}^{VRB}} ] \\ {P}_{s , i}^{VRB} ∈ [ \underline{{P}_{k , i}^{VRB}} , \overline{{P}_{k , i}^{VRB}} ] , & else\end{matrix}$$
$$\{ \begin{matrix}{P}_{re , k}^{VRB} = 0 , & if {SoC}_{re , k}^{VRB} ∉ [ \underline{{SoC}_{re , k}^{VRB}} , \overline{{SoC}_{re , k}^{VRB}} ] \\ {P}_{\text{?}}^{VRB} ∈ [ \underline{{P}_{re , k}^{VRB}} , \overline{{P}_{re , k}^{VRB}} ] , & else\end{matrix} ,$$
$$\text{?} \text{indicates text missing or illegible when filed}$$
where P_{D,Lo}^{VRB} and P_{D,re}^{VRB} represent load powers of a two-layer network in the microgrid cluster with vanadium redox flow battery, P_{k,i}^{VRB},P̅_̅{̅k̅,̅i̅}̅^̅{̅V̅R̅B̅}̅ and SoC_{k,i}^{VRB},S̅o̅C̅_̅{̅k̅,̅i̅}̅^̅{̅V̅R̅B̅}̅ are a minimum/maximum output power and a minimum/maximum SoC of the i-th battery in a k-th microgrid respectively, while P_{re,k}^{VRB},P̅_̅{̅r̅e̅,̅k̅}̅^̅{̅V̅R̅B̅}̅ and SoC_{re,k}^{VRB},S̅o̅C̅_̅{̅r̅e̅,̅k̅}̅^̅{̅V̅R̅B̅}̅ are a minimum/maximum output power and a minimum/maximum SoC of the battery in a k-th representative node;
S523, KKT conditions of the vanadium redox flow battery are:
$$\{ \begin{matrix}\frac{\partial {F}_{Lag} ( {P}_{k , i}^{VRB} )}{\partial {P}_{k , i}^{VRB}} = \frac{\partial {f}_{k , i}^{VRB} ( {P}_{k , i}^{VRB} )}{\partial {P}_{k , i}^{VRB}} - {k , i}_{VRB}^{} = {a}_{VRB , c} {SoC}_{k , i}^{VRB} + {b}_{VRB , c} - {k , i}_{VRB}^{} = 0 \\ \frac{\partial {F}_{Lag} ( {P}_{re , k}^{VRB} )}{\partial {P}_{re , k}^{VRB}} = \frac{\partial {f}_{re , k}^{VRB} ( {P}_{re , k}^{VRB} )}{\partial {P}_{re , k}^{VRB}} - {re , s}_{LB}^{} = {a}_{VRB , c} {SoC}_{re , k}^{VRB} + {b}_{VRB , c} - {re , k}_{VRB}^{} = 0\end{matrix} ,$$
S524, an optimal solution is derived as:
$$\{ \begin{matrix}{k , i}_{VRB}^{} = {a}_{VRB , c} {SoC}_{k , i}^{VRB} + {b}_{VRB , c} , & as & {SoC}_{k , i}^{VRB} ∈ [ \underline{{SOC}_{k , i}^{VRB}} , \overline{{SOC}_{k , i}^{VRB}} ] \\ {re , k}_{VRB}^{} = {a}_{VRB , c} \underline{{SOC}_{k , i}^{VRB}} + {b}_{VRB , c} , & as & {SoC}_{k , i}^{VRB} ∈ \underline{{SOC}_{k , i}^{VRB}} \\ {re , k}_{VRB}^{} = {a}_{VRB , c} \overline{{SOC}_{k , i}^{VRB}} + {b}_{VRB , c} , & as & {SoC}_{k , i}^{VRB} ∈ \overline{{SOC}_{k , i}^{VRB}}\end{matrix}$$
$$\{ \begin{matrix}{re , k}_{VRB}^{} = {a}_{VRB , c} {SoC}_{re , k}^{VRB} + {b}_{VRB , c} , & as & {SoC}_{re , k}^{VRB} ∈ [ \underline{{SOC}_{re , k}^{VRB}} , \overline{{SOC}_{re , k}^{VRB}} ] \\ {re , k}_{VRB}^{} = {a}_{VRB , c} \underline{{SOC}_{re , k}^{VRB}} + {b}_{VRB , c} , & as & {SoC}_{re , k}^{VRB} ∈ \underline{{SOC}_{re , k}^{VRB}} \\ {re , k}_{VRB}^{} = {a}_{VRB , c} \overline{{SOC}_{re , k}^{VRB}} + {b}_{VRB , c} , & as & {SoC}_{re , k}^{VRB} ∈ \overline{{SOC}_{re , k}^{VRB}}\end{matrix} .$$

9. An electronic device comprising a memory, a processor, and a computer program stored in the memory and executable on the processor, wherein when the processor executes proposed program, it implements the hierarchical distributed control method for the microgrid cluster with the heterogeneous batteries according to claim 1.

10. A non-transitory computer-readable storage medium storing a computer program, wherein when the computer program is executed by a processor, it implements the hierarchical distributed control method for the microgrid cluster with the heterogeneous batteries according to claim 1.
